(19) United States
(12) Patent Application Publication
(10) Pub. No.: US 2008/0189163 A1
(43) Pub. Date: Aug. 7, 2008

(54) INFORMATION MANAGEMENT SYSTEM

(75) Inventors: Dov Rosenberg, San Bruno, CA (US); Peter Eberlely, San Bruno, CA (US)

Correspondence Address: Stolowitz Ford Cowger LLP, 621 SW Morrison St, Suite 600, Portland, OR, 97205, US

(73) Assignee: Inquira, Inc., San Bruno, CA (US)

(21) Appl. No.: 12/024,630

(22) Filed: Feb. 1, 2008

Related U.S. Application Data
(60) Provisional application No. 60/888,240, filed on Feb. 5, 2007.

(51) Int. Cl. G06Q 10/00

(52) U.S. Cl. 705/9; 705/1

(57) ABSTRACT

An information management process generates channels that automatically send tasks to different users for different work flow stages according to different attributes assigned to the channel. The tasks may then be automatically sent back to the same users or to other different users in other work flow stages according to the channel attributes and conditions associated with the work flow stages. The information management process can be integrated with a search process and an analytics process to provide a closed loop information system.

This application claims priority to U.S. Provisional Patent Application Ser. No. 60/808,240, filed Feb. 5, 2007 which is incorporated by reference in its entirety.

### BACKGROUND

Enterprises use the Internet to conduct on-line transactions and to provide information to enterprise customers. Consumers can purchase products and services and get information related to those product and services on-line over the Internet. However, enterprises continuously struggle to provide current and relevant information to customers.

For example, an enterprise providing financial services may have to continuously replace or update web pages to reflect new interest rates. Other enterprises may have to continuously add content for new products and remove or update content for obsolete products. Other on-line enterprises, such as those providing news reporting services, have an even greater challenge since web information has to be updated every day.

Creating new content and updating existing content is time consuming and expensive. For example, enterprise personnel need to analyze the web site to first determine when and what new content is required. Other enterprise personnel may then have to create new content or edit identified obsolete content. Then other enterprise personnel may need to review the new or revised content before the new content is published on the enterprise website. The content may first have to be reviewed by technical experts for technical accuracy and then reviewed by the enterprise legal department to consider any legal implications related to the new content.

It is difficult to manage these different stages of content development. First of all, the different recommendations for new or updated content need to be tracked. Enterprise customers and enterprise call center personnel may continuously provide comments and recommendations for new content. All of these recommendations then need to be accumulated, analyzed and possibly converted into a content recommendation. Each new content recommendation has to then go through a content creation stage, review stage, and publication stage. Delays or omissions in any of the required content development stages can either delay the publication of new content or result in low quality out of date content.

### BRIEF DESCRIPTION OF THE DRAWINGS

FIG. 1 is a diagram showing a closed loop information system.

FIG. 2 is a block diagram showing an Information Management (IM) process used in the closed loop information system of FIG. 1.

FIG. 3 is a more detailed diagram showing a work flow managed by the IM process.

FIG. 4 is a block diagram of another conditional work flow managed by the IM process.

FIG. 5 is a block diagram showing how the IM process is used for ranking content and content authors.

FIG. 6 is a block diagram showing how unassigned or aging tasks are managed by the IM process.

FIG. 7 is a block diagram showing how the IM process identifies outdated content.

### DETAILED DESCRIPTION

### Closed Loop Information Management

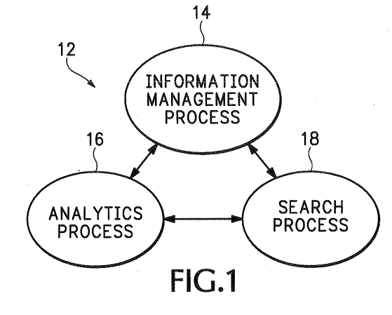

FIG. 1 shows a closed loop information system 12 that includes three different information processes or stages. A search process 18 conducts search operations for retrieving and identifying information related to a particular search query. The database information accessed in search process 18 can either be located in an internal enterprise data repository or located externally, for example, on an external server accessed by the enterprise over the Internet.

The information sought during the search process 18 can be any type of structured or unstructured document, database information, chat room information, or any other type of data or content that may be relevant to a particular search request. Some examples of intelligent information query systems used in the search process 18 are described in co-pending patent application Ser. No. 11/382,670, filed May 10, 2006, entitled: GUIDED NAVIGATION SYSTEM; and Ser. No. 10/820,341, filed Apr. 7, 2004, entitled: AN IMPROVED ONTOLOGY FOR USE WITH A SYSTEM, METHOD, AND COMPUTER READABLE MEDIUM FOR RETRIEVING INFORMATION AND RESPONSE TO A QUERY, which are both herein incorporated by reference. Of course these are just examples and any search process 18 can be used in conjunction with closed loop information system 12. For example, any conventional search engine or information retrieval system can be used as part of search process 18.

An analytics process 16 is used for both analyzing the results from the search process 18 and possibly providing inputs for improving the search process. For example, the analytics process 16 may track the relevancy of information provided to users for different search or query requests. For instance, the analytics process 16 may determine what content the user opens and reads or what additional questions the user still has after receiving search engine responses. The analytics process 16 may monitor any variety of different user feedback to determine how effective the search process 18 is in providing answers to user queries.

The analytics process 16 then provides feedback to the search process 18. For example, groups of user queries are analyzed to identify the most frequently asked questions. The search engine database is then updated to ensure information exists that is responsive to those common questions. In one embodiment, the analytics process 16 determines the intents of user questions and uses the identified intents to classify existing enterprise content. The search process 18 can then use the reclassified content to provide better responses to user questions.

One example of this type of analytic process is described in co-pending patent application Ser. No. 11/464,443, filed Aug. 14, 2006, entitled: METHOD AND APPARATUS FOR IDENTIFYING AND CLASSIFYING QUERY INTENT which is herein incorporated by reference. Of course this is just one example of operations that may be performed in analytics process 18.

An Information Management (IM) process 14 is used for “closing the loop” with the search process 18 and the analytics process 16. The IM process 14 is used for creating, editing, reviewing, ranking, etc. content and content related tasks that may be identified by the analytics process 16 and then used by the search process 18. The IM process 14 creates work flows that automatically assign and distribute content and related tasks to qualified enterprise personnel. The IM process 14 then monitors the work flows to ensure the content and related tasks are timely processed. The IM process 14 can also be used for both rating content and rating the reputation of the authors creating the content.

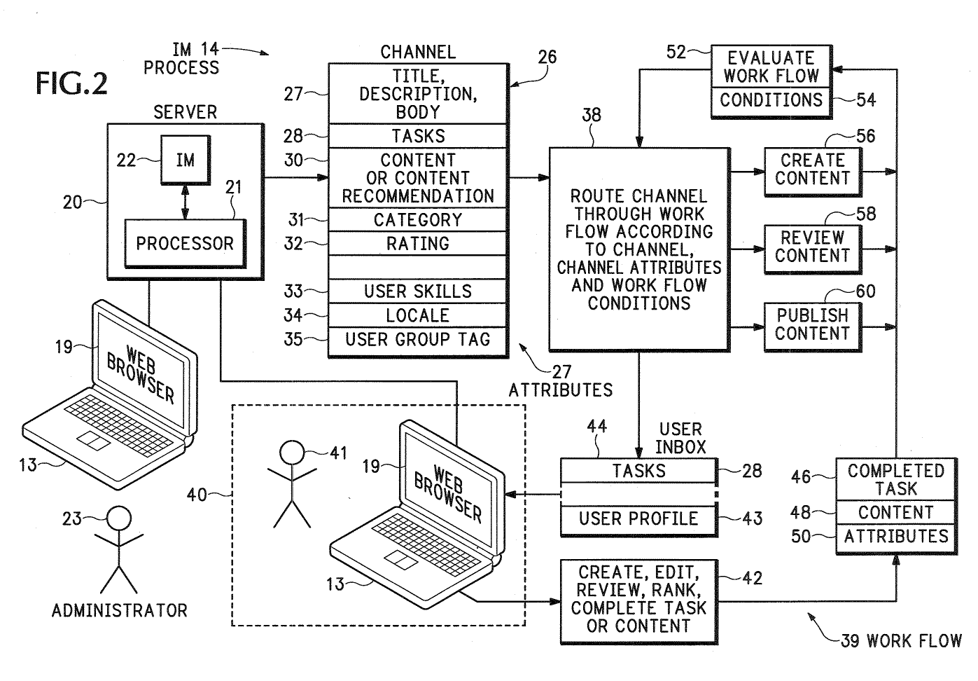

FIG. 2 shows how the IM process 14 creates channels and associated work flows. A computer terminal 13 operates a User Interface (UTI) such as a web browser 19 that accesses a server 20 via a Local Area Network (LAN) or via the Internet. The server 20 includes a processor 21 that executes Information Management (IM) application software 22. The IM application 22 comprises computer instructions that are stored in memory and when executed by processor 21 perform the IM process operations described below.

An administrator 23 can be anyone having the authority to create content, provide content recommendations, or manage the tasks associated with creating and reviewing content. For example, administrator 23 could be a call center agent that receives calls from enterprise customers. The call center agent may use the enterprise search process 18 (FIG. 1) for answering customer questions. When the search process 18 does not provide the correct answer, the call center agent may send a content recommendation to the IM process 14 requesting creation of new content responsive to the user question. The administrator 23 can also be an enterprise manager that creates channels that then automatically send tasks to enterprise personnel requesting the creation of new content pursuant to content recommendations.

The IM application 22 manages content through the creation and definition of content channels 26. The content channel 26 is composed of an arbitrary number of attributes 27 and defined behaviors that control the management of content in the channel 26. The behaviors may include workflow definitions, data validations, security constraints, email and task notifications, or associations to other content.

In one embodiment, the content channel 26 may include a title, description and body 27. The title, or an alternative tag, may be associated with a particular technology area or enterprise group. The tag then causes the associated channel information to then be distributed to users within the associated group.

For example, enterprise customers may ask questions to a search engine that do not have adequate answers available. The analytic process can help administrators determine the nature of the questions being asked that were not adequately answered. The administrator 23 can use that information to create a new channel 26 or to create content in an existing channel 26 in which to store content 30 that better answers the questions.

The enterprise administrator 23 may generate a white paper responding to the questions that includes a title, keywords, categories, etc. The administrator 23 can create a content channel 26 that automatically causes the white paper to show up in the email inboxes of enterprise staff. The channel 26 may describe the subject matter of the white paper and the tasks that need to be performed on the white paper. The content 30 contained in the channel 26 then may be automatically directed to enterprise staff having responsibilities and expertise in the subject matter identified by the channel 26. The enterprise staff can then start adding white papers to the channel, web designers can then start laying out graphics for the channel, etc.

The channel 26 can have different attributes 27 that may include tasks 28 that identify work flow activities. The channel 26 can also includes content records and/or content recommendations 30 that either identify what content needs to be created or contains the created content at different work flow stages. The content 30 can also include different categories 31 and ratings 32. The categories 31 may determine who is responsible for working on content 31 or the conditions for moving the content through a work flow. The ratings 32 associate a quality value with the content 30 or the content author.

A user skills attribute 33 identifies the user skills required for working on the tasks 28. A locale attribute 34 identifies a particular location where the content or task will be used. For example, on a Japanese or German web site.

The content records 30 can be secured using user groups. A user group is a tag 35 that is defined in an IM repository in server 20 that controls access to the content records 30 that are distributed out of the IM repository via the IM web services or the IM tag library. A content record 30 or individual attributes 27 of the content record 30 can be secured using the user group security tags 35. The security tags 35 are used as content restrictions in the search engine to ensure only authorized personnel have access to the content record 30.

For example, the content record 30 may only be used internally inside the enterprise. Accordingly, the content record 30 may be assigned to a user group having a SECURITY=PRIVATE tag 35. Other content 30 may be eventually accessible by any enterprise customer. Accordingly, the content may be assigned to a public user group tag 35 where SECURITY=PUBLIC. The type of security tag 35 may determine what level of review is required for content 30. This will be described below in more detail.

### Workflows

IM workflows 39 are comprised of one or more user defined workflow steps. A workflow definition is assigned to one or more content channels 26 to control how a content record 30 moves thru its lifecycle prior to publishing. Each step of the workflow can have one or more conditions that are tested to determine which work flow step will occur next and who would be eligible to perform the step. A workflow condition is computed based on the following pieces of data: locale of the content record 30, user skills of the user, assigned categories, associated repository view, work team, and content channel 26.

There are rules configured in the content channel 26 that determine if a workflow event is generated based on certain attributes changing. For example it may be possible to NOT trigger a workflow task if the attribute is configured not to initiate a workflow if changed.

The IM process 14 in operation 38 may create a work flow step 56 for the channel 26 where a user may have the initial task of creating new content. In a second review content work flow step 58, a notification associated with the channel 26 may be sent to users responsible for reviewing the content created in work flow step 56. A publish work flow step 60 may send the reviewed content to a repository or database for publication on the enterprise website.

Each work flow step may include one or more conditions 54 that must be satisfied prior to the IM process 14 moving to a next work flow step in operation 52. These conditions may depend on the attributes 27 associated with the channel 26. For example, operation 52 may not move to the review work flow step 58 until content has been created in content creation step 56 by a user having the specified user skills 33. If the content has a SECURITY=PUBLIC tag 35, operation 52 may not move to publish work flow step 60 until the content is first reviewed by a user having a profile corresponding with a SECURITY=PUBLIC tag 35.

In one example, a work station 40 for a user 41 receives notifications associated with the channel 26 in a network or email inbox 44. The work station 40 also includes a computer terminal 13 that accesses the server 20 via the Internet and accesses the IM application software 22 through a web browser 19.

The user 41 logs into the IM application 22 via web browser 19 and is taken to inbox 44 which lists all of the available tasks 28 that the user 41 is ELIGIBLE to perform based on the security roles that are assigned to the user 41. Content 30 is stored in channel 26 and notifications are sent to the inbox 44 about tasks 28 that the user 41 needs to perform.

The user 41 has a user profile 43 associated with a user login. When the user 41 logs in, they are brought to the inbox 44 to review all open tasks 28 that they are eligible to perform. The user 41 may be granted permissions by the administrator 23 to change some of their user profile settings that can change the types of tasks 28 that the user 41 is allowed to see. Specifically, the user 41 may be granted the ability to change their own user skills which could affect the type of tasks 28 they can perform.

As content 30 is created in the channel, it is routed thru the workflow process 39 based on the rules and conditions established by the administrator 23. As the content record 30 enters each step of the workflow, a task 28 is created by IM 22 and notifications are sent to all console users 41 whose profile 43 matches that of the newly created task.

The user 41 in operation 42 completes the tasks 28 received in inbox 44. For example, the user 41 may be required to create new content, review or edit existing content, rank content, etc. The completed task 46 along with any associated content 48 and attributes 50 are then automatically forwarded to the next work flow stage, if any, in operation 52. For example, the IM process 14 in operation 52 first determines the current work flow stage for creating content has been completed. Based on the completion of one of conditions 54, operation 52 then may send the content 30 back through another work flow 39 for reviewing, editing, publishing, ranking, etc., the content 48.

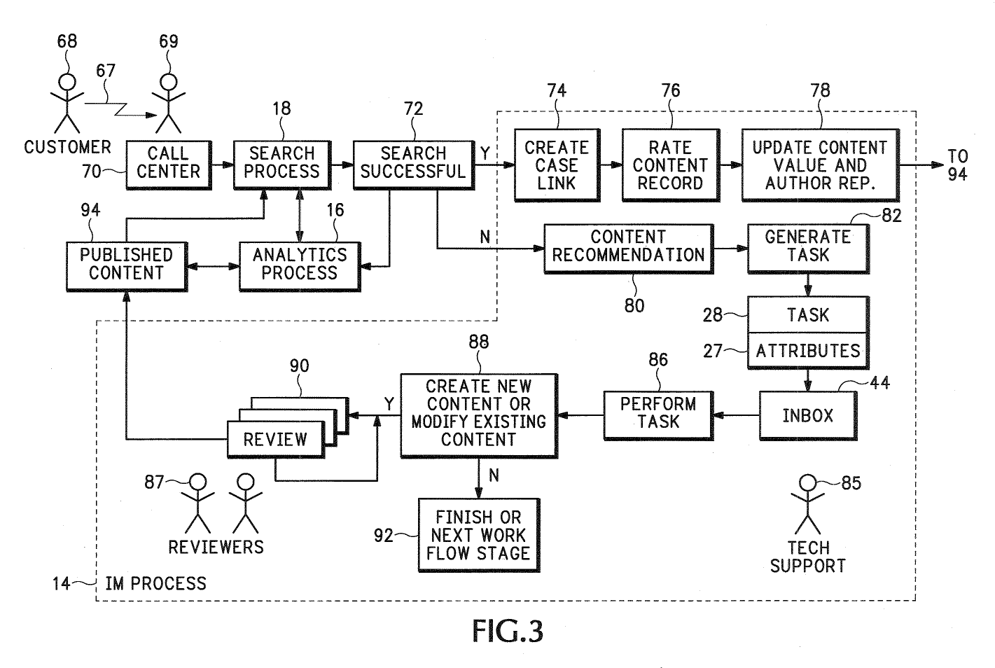

FIG. 3 shows one particular work flow in more detail. In this example, a call center agent 69 at an enterprise call center 70 receives a phone call, email, or on-line chat communication 67 from a customer 68. The customer 68 can be any one that contacts the call center agent 69 to ask for particular information related to the enterprise. For example, the customer 68 may have asked call center agent 69 how to operate a product sold by the enterprise. The call center agent 69 may then use search process 18 to locate the information responsive to the customer query.

If the search process 18 is successful in identifying information related to the query, the call center agent 69 may then click on a link to a web page containing the requested information and communicate the information to customer 68. Alternatively, the call center agent 69 may inform the customer 68 where to locate the desired information on the enterprise web site. If several similar questions are asked, the call center agent 69 may use the IM process 14 to post a content recommendation 80 that requests creation of a link to the identified web page at appropriate locations on the enterprise web site. Providing this link could then reduce the number of calls to call center operator 69 since customers 68 would then be more likely to locate the correct information without human assistance.

In an alternative scenario, the search operation 18 may be unsuccessful locating information responsive to the question from customer 68. For example, the call center agent 69 may not be able to locate information on the enterprise website that explains how to operate the product purchased by customer 68. The call center agent 69 may then use the IM process 14 to generate a new content recommendation 80. This may include the call center agent 69 identifying the product and associated question received from customer 68. Alternatively, the content recommendation 80 may simply contain the query submitted to the search process 18 by the call center agent 69 and the results received back from search process 18.

The IM process 14 is used to generate a channel and associated tasks 28 in operation 82 that requests the creation of new content responsive to the content recommendation 80. The IM process 14 automatically sends the task 28 to the inboxes 44 of any technical support personnel 85 qualified for creating the content requested in task 28. In the example given above, the IM process 14 may automatically send the task 28 to the inbox 44 of enterprise technical support personnel 85 qualified to provide content explaining how to operate a cellular telephone sold by the enterprise.

In one instance, the IM process 14 may broadcast the task 28 to all personnel assigned to a particular technical support user group. Alternatively, the IM process 14 can assign attributes 27 that identifies particular user skills, categories, permissions, etc., required for working on task 28. The IM process 14 then automatically sends the task 28 to the inboxes 44 of any enterprise personnel having user profiles 43 (FIG. 2) matching certain attributes 27 associated with the task 28.

The one or more technical support personnel 85 can then review the information in task 28 that may include the original content recommendation 80 from the call center agent 69. As mentioned above, this can include the specific question asked by the customer 68, the specific search request entered into a search engine by the call center agent 69, and the results received back from the search engine. The tech support personnel 85 complete the task 28 in operation 86 which may include, but is not limited to, creating new content for the enterprise website, editing existing content, reclassifying database information used by the search process 18, or creating a new link on the enterprise website.

The tech support agent 85 may also generate new tasks. For example, the technical support person 85 may determine that published content 94 on the enterprise website provided the answers to the customer query. However, it may be determined by user 85 that the search terms used by call center agent 69 did not locate the correct information. The technical support personnel 85 may then create a new task requesting creation of a new link or reclassification of one or more intent categories used by the search process 18 for responding to queries. This process is described in the co-pending patent application Ser. No. 11/464,443 which has already been incorporated by reference.

When new content is not required, the work flow may either be completed in operation 92 which may then automatically notify the call center agent 69 of the completed content recommendation 80. New tasks generated by the technical support personnel 85 may be sent back through the IM process work flow in operation 92. When new content is created or existing content is modified in operation 88, the new or modified content may automatically be routed by the IM process 14 through a review work flow in operation 90. This may require several other enterprise personnel 87 to review the content created or modified by technical support personnel 85.

The content reviewers 87 may include the call center agent 69 that originally posted the content recommendation 80. This allows the call center agent 69 to then determine if the new content sufficiently responds to the previously unanswered question by customer 68. Several different enterprise staff may need to review the new content. The IM process 14 may either sequentially, or in parallel, send the content to the inboxes of each required reviewer 87.

After the review work flow stage is completed in operation 90, the IM process 14 may forward the reviewed content to the enterprise database repository 94 that can then be publicly accessed and/or used by the search process 18. Thus, the IM process 14 provides a closed loop system for both generating content recommendations and generating content responsive to those content recommendations.

In one embodiment as described above, the content recommendations 80 are manually created by the call center agent 69 using the web browser 19 and IM application 22 previously shown in FIG. 2. Alternatively, the call center agent 69 or customer 68 may simply send an email to the enterprise that is then processed by enterprise personnel responsible for creating content recommendations 80.

In yet another embodiment, the analytics process 16 (FIG. 1) automatically identifies the intent of customer or operator queries and then, if necessary, automatically creates content recommendations 80. For example, the analytic process 16 may automatically identify a threshold number of similar queries having no responsive content in repository 94. The analytics process 16 then automatically generates a content recommendation 80 that corresponds to the common query intent. The IM process 14 then automatically creates a channel that is then used for creating content responsive to the content recommendation 80.

Another analytic process 16 may use industry experts to periodically compare the current published content in database(s) 94 with previously submitted queries. These experts can then generate content recommendations 80 or generate new tasks for reclassifying existing content in repository 94 to better correspond with the user queries. One example of these automatic and/or manual analytics processes 16 are described in co-pending application Ser. No. 11/464,443 which is incorporated by reference.

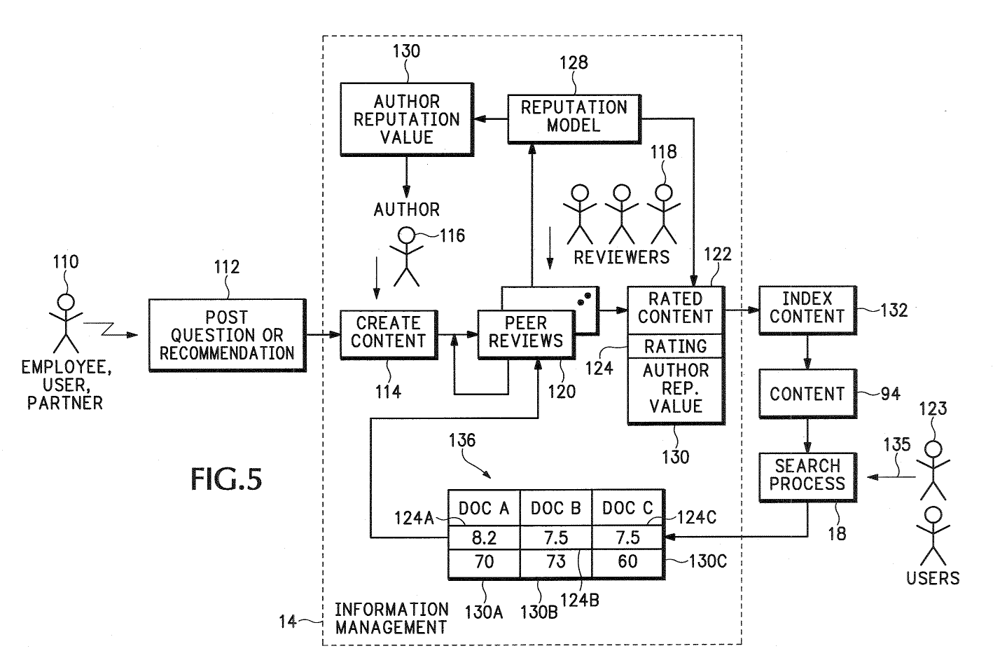

The call center agent 69 may also use the IM process 14 to create a case link in operation 74 and rate the relevance of the content received back from the search process 18 in operation 76. The IM process 14 can then automatically update content ratings and associated author reputation ratings in operation 78. The content rating and author reputation ratings are then used to adjust the rankings for content in database 94. This is described in more detail below in FIG. 5.

### Conditional Work Flow

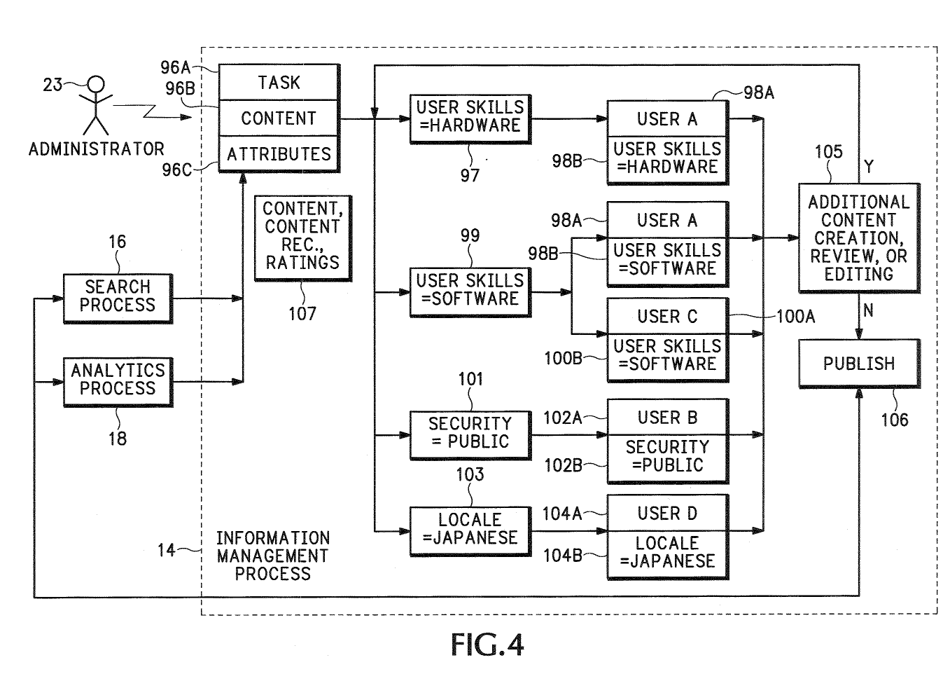

FIG. 4 shows another example of how the IM process 14 provides a conditional work flow that conditionally routes tasks to different users. An administrator 23 creates a channel that includes content 96B and associated attributes 96C and produces an associated task 96A. Operation 97 in IM process 14 determines one of the attributes 96C associated with the channel is USER SKILLS=HARDWARE. The IM process 14 in operation 98 accordingly sends the task 96A to the inbox 98A of a user A having a user profile 98A corresponding with the USER SKILLS=HARDWARE attribute 96C.

The IM process in operation 99 may determine that the same channel also has an attribute USER SKILLS=SOFTWARE. In this example, the profile 98B for user A has both USER SKILLS=HARDWARE and USER SKILLS=SOFTWARE parameters. The profile 100B for user C also has the USER SKILLS=SOFTWARE parameter. Accordingly, the IM process sends a task 96A to the inbox 98A of user A and the inbox 100A for user C. In one example, the workflow for IM process 14 then assigns task 96A to whichever user A or user C first clicks on task 96A in their inbox.

The workflow for the IM process 14 in operation 105 receives the completed tasks from users A and/or C and determines if other workflow stages are required. Operation 101 determines if the same channel has another SECURITY=PUBLIC tag 96C. In this example, a user B has a user profile 102B configured with the SECURITY=PUBLIC tag. User B may work in the enterprise legal department and is required to approve all content prior to being published on the enterprise web site. Accordingly, the IM process workflow in operation 101 sends a task 96A to the inbox 102A of user B.

In a next work flow stage, the IM process in operation 103 determines that the channel also has a LOCALE=JAPANESE attribute 96C. For example, content associated with the channel may be used on an enterprise website in Japan. In this case, a user D is fluent in Japanese and accordingly has a user profile 104B configured with LOCALE=JAPANESE. Accordingly, a task 96A is then sent to the inbox 104A of user D.

The IM process 14 conditionally feeds the content 96B back through the work flow in operation 105 based on different conditions and channel attributes 96C. For example, a first condition may require the tasks associated with the HARDWARE and SOFTWARE attributes to be completed first.

After the tasks associated with the HARDWARE and SOFTWARE attributes are completed, the IM process 14 in operation 105 feeds the content back through the work flow for review by user B associated with the SECURITY=PUBLIC attribute. The IM process 14 in operation 105 then sends a notification back to the inbox 104A of user D with a task 96A for converting the reviewed content into JAPANESE. Only after the tasks associated with these four conditions are completed, does the IM process 14 in operation 105 forward the content 96B onto publication operation 106.

The content published in operation 106 is then available to both the search process 18 and the analytics process 16 in FIG. 1. Both the analytics process 16 and search process 18 can then feed any query or analytic information back to the IM process 14 for further content creation or refinement. For example, user ratings, content recommendations, or any other user or enterprise feedback 107 can be sent to the IM process 14 to either create, correct, or fine tune existing enterprise content.

### Ranking Content

FIG. 5 shows how the IM process 14 is used for rating content and content authors. One goal of the information system 12 shown in FIG. 1 is to continuously improve the quality of content provided to users. Quality can refer to many different factors but, in one instance, refers to quickly and easily providing all the information needed to answer user questions. One way to improve quality is to continuously review and rate content. This rating can come both from enterprise employees, industry experts, and directly from customers.

A content provider 110 is any enterprise employee, client, customer, user, or business partner. The content provider 110 posts a question or content recommendation 112 to the IM process 14. For example, the content provider 110 may send a message to the enterprise web site saying the enterprise web site does not explain how to format a hard disc. This recommendation 112 can be posted through any variety of different communication processes. For example, the question or content recommendation can be posted via an Internet chat room, through an information query system (search engine) used for responding to user questions, via email, or via a call center agent talking to a customer over the phone. Any other type of communication process can also be used to notify IM process 14 of a question or recommendation 112.

As described above, the IM process 14 in operation 114 then creates content responsive to the posted question or content recommendation 112. The author 116 of the content 14 can be anyone either internal to the enterprise or external to the enterprise. For example, the author 116 could be the same person that posted the question or recommendation 112. Alternatively, the author 116 could be an expert employed by the enterprise or a third person that responds to a posting 112 on a website chat room.

The content is rated by reviewers 118 in peer review operation 120. In one example, the review operation 120 may use the same IM process 14 described in FIG. 3. For example, the content 114 may be automatically routed to different enterprise personnel through an associated IM channel. Alternatively, the content 114 may be reviewed by non-enterprise employees through external communication channels, such as through a chat room, via a search engine, or email communications. Content can be reviewed in the management console by reviewers of the document but content can also be reviewed by users on the enterprise web site.

The reviewers 118 rate the content 114 during the review process 120. This can be as simple as the reviewers 118 assigning a number to the document. For example, a high positive number can represent a high quality/value highly relevant document and a low or negative number can represent a low quality/value irrelevant document. The point system associated with desired activities, such as rating content, can be customized by the type of users, such as console users or web users.

The IM process 14 monitors all of the ratings assigned to the document by the different reviewers 118 and then assigns the content 122 an overall rating 124. In one embodiment, the rating 124 may be the average value for all of the individual ratings from the reviewers 118. In another embodiment, the ratings from different reviewers 118 may be weighted differently. A rating from an acknowledged industry expert may be given more weight than a rating from an unknown reviewer 118. For example, the rating from the industry expert may be multiplied by 10 while a rating from an unknown reviewer may be multiplied by 1. Of course this is just one example, and in other cases ratings from enterprise customers may be weighted equally or greater than some enterprise personnel.

The users 110, reviewers 118, authors 116 and anyone else may be given incentives or rewards for interacting with the content rating process. Participants may get promotional discounts, credits, or some sort of acknowledgement for contributing to the content ranking process.

The IM process 14 may also include a reputation model 128 that assigns reputation values 130 to the authors 116 that create content in operation 114. The reputation values 130 can be varied according to the rating 124 assigned to content 122. For example, a high rating 124 for content 122 may increase the reputation value 130 assigned to the author 116. The author reputation value 130 can also be attached to the rated content 122.

An IM crawler 132 indexes the rated content 122 for integration into search process 18. For example, the IM crawler 132 may index or rank content in particular intent categories or subject areas according to the content ratings 124 and/or author reputation values 130. The IM crawler 132 has in-depth knowledge of the attributes for content located in database 94. For example, different fields in a structured database 94 may classify content by subject matter, content creator, when created, security level, etc. This allows the IM crawler 132 to also further index the content in database 94 according to content ratings 124 and author reputation values 130.

The indexed content in database 94 is then used by the search process 18 when responding to queries. For example, a user 123 may request the search process 18 to identify the most helpful content that relates to a user query 135. The search process 18 displays results 136 according to the content ratings 124. Document A has the highest rating 124A and is according displayed first, document B with the second highest ranking 124B and is displayed next, etc.

When different content has the same rating 124, the content having the higher author reputation value may be displayed first. For example, content ratings 124B and 124C are the same for documents B and C, respectively. However, the author reputation value 130B for document B is higher than the author reputation value 130C for document C. Accordingly, document B is displayed before document C.

In another embodiment, the user 123 may request the search process 18 to display content according to author reputation values 130. In this example, document B would be displayed first, document A displayed second, and document C displayed third. Thus, content created by highly respected or popular authors may be displayed before content created by unknown authors or authors that have historically provided less helpful information.

The IM process 14 provides yet further iterative content evaluation by allowing the users 123 to further rate the already rated content in database 94. For example, the user 123, through the search process 18, may assign their own rating 124 to any of documents A, B, or C. These new user ratings are periodically analyzed by the IM process 14 and/or the analytics process 16 (FIG. 4) and the overall content ratings 124 adjusted accordingly. Some content 122 may initially have high ratings 124, but over time may become less relevant to users 123. Accordingly, the users 123 may start assigning lower content ratings. The IM process 14 or analytics process 16 over time may then reduce the overall rating for that content and possibly reduce the reputation value 130 for the author 116 creating the content. If a rating falls below some predetermined threshold value, the associated content 122 may be automatically removed from database 94.

Rating can also be automatically varied according to how often users reference content 122. The IM process 14 in peer review operation 120 may track the number of times users 123 select links to particular content. The rating 124 may then be increased as more users 123 access the content 122. A call center agent may also assign case links to content that includes a case identifier. The IM process 14 may adjust the content rating 124 according to the case link values assigned to the content 122 by the call center agents. The rating 124 may be higher than the individual case link values assigned by the call center agents when many different agents reference the same content.

Rating 124 may also vary according to the author 116 creating the content 122. For example, a legal document generated and ranked highly by the enterprise legal department may result in a higher rating 124 than a legal document created and rated by the enterprise engineering department. Similarly, someone from the legal department rating a technical document related to database management may be given less weight than a rating made by a software engineer.

The reputation model 128 may assign different reputation values 130 according to different criteria. For example, an author 116 creating 15 different documents related to a particular subject matter may originally get a higher reputation value 130 than an author 116 of only one document for the same subject matter. However, over time, more users 134 may access the single document from the second author more than all of the 15 documents created by the first author. In this situation, the IM process 14 or analytics process 16 may over time increase the reputation value 130 for the second author 116 while possibly reducing the reputation value of the first author.

Thus, the IM process 14 collects questions and content recommendations 112 and then automatically moves responsive content 114 through a continuous closed loop review and rating process.

### Automated Task Management

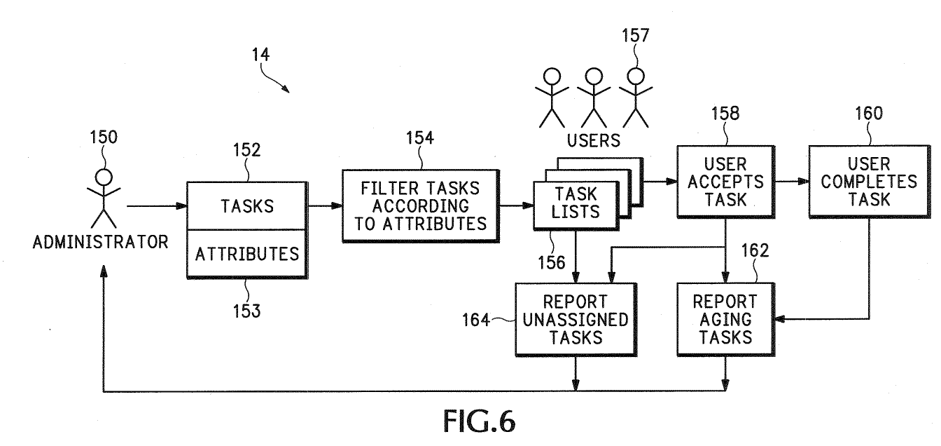

FIG. 6 shows in more detail how the IM process 14 provides automated task management. An enterprise administrator 150, or other user, may create a channel that has an associated task 152. For example, the task 152 can request the creation, editing, reviewing, or approving of content. As described above with respect to work flows, some tasks 152 may require completion or approval by a first user 157 before the content is routed through the associated channel to other users 157. Also as described above, the channel can include different attributes 153 such as user skills, content categories, locale, security, etc., that determine what specific users 157 will receive particular tasks.

As also described above, the IM process 14 filters the tasks 152 in operation 154 according to the associated attributes 153. In other words, the IM process in operation 154 sends the tasks 152 to the inboxes 156 of users 157 having profiles with matching attributes 153. In one embodiment, the users 157 accept tasks in operation 158 by clicking on the task 152 in their inbox 156. For tasks sent out to more than one user 157, the task 152 may be automatically assigned to the first user 157 that clicks on the task 152 in their inbox 156.

In one embodiment, the IM process 14 maintains timers for both unassigned and assigned but uncompleted tasks. For example, the IM process 14 may start a first timer in operation 164 as soon as a task 152 is sent to the inbox 156 of one or more users. The timer continues until the task is selected by one of the users 157.

If no user accepts the task by clicking on the task in their inbox 156 within some predetermined time threshold, operation 164 may automatically send a notification to all of the users 157 originally receiving the task that the task has still not been accepted. If no one has selected the task 152 after another predetermined time threshold, operation 164 may send a notification to the administrator 150 originally creating task 152. The administrator 150 can then either assign the task to a specific user 157 or re-notify users 157.

A user may finally accept a task in operation 158. Another operation 162 then tracks how long it takes the user 157 to complete the accepted task. If the user does not complete the task in operation 160 within some predetermined time period after accepting the task in operation 158, a notification may be automatically sent either to the administrator 150 and/or to the user 157 in operation 162 indicating the task 152 has still not been completed. If the user 157 still does not complete the task after a number of repeated notices, or after some second predetermined time period, the IM process 14 may again notify administrator 150 and/or automatically resend the task 152 a different qualified user 157.

The analytics component 16 (FIG. 1) provides both operational reports (based off of live data) and analytic reports based off of historical data. The analytic reports track the performance of task assignment and completion by work teams, individuals, and repositories.

### Time Based Content

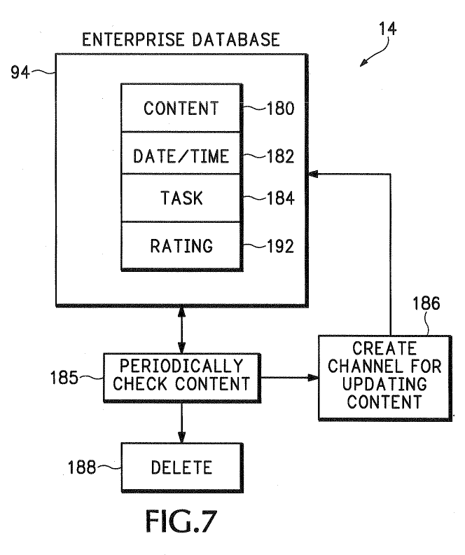

FIG. 7 shows how the IM process 14 can be used to automatically update and/or remove obsolete content from the enterprise database 94. For example, some of the content 180 for a financial services enterprise may contain information related to interest rates. Since interest rates frequently change over time, some of the content 180 may need to either be periodically updated with new interest rates or deleted.

A date/time attribute 182 is added to this type of time sensitive content 180. An associated task 184 may also be assigned to the channel that is associated with content 180 indicating what the IM process 14 should do with the content 180 after the time associated with data/time attribute 182 has expired.

The IM process in operation 185 periodically parses through the content in database 94 for any material that may have an expired date or time stamp value 182. In other words, the IM process in operation 185 automatically determines when a current date or time extends past the date or time attribute 182 associated with any content 180.

Based on rules established during the content channel setup/configuration, expired content notifications are sent to the original content author either prior to the actual expiration (a configurable number of days) or after the content has expired (configurable number of days). Multiple notifications can be configured to be sent. The notifications are available in the task inbox 44 and can be clicked on to be performed.

The IM process 14 in operation 185 the task 184 associated with the expired content 180 may request the user in operation 186 to generate a new channel 190 and send the expired content 180 back through the IM process 14 for updating. Similarly to what was described above, the task 184 associated with the new channel and the associated content 180 may be automatically sent to enterprise personnel authorized to update the content 180. In the example where the content 180 contains interest rates, the IM process 14 may automatically send Lie content 180 to an expert working for the financial institution that has authority to change the current interest rates on enterprise web pages. After completion of the task 184 that requests interest rate updates, the IM process 14 may automatically send the updated content 180 back to the database 94 that provides information to the financial institution website.

Other content 180 may be completely obsolete after some specified date or time 182. For example, the enterprise may have created content for a temporary product or service promotion. According, the associated task 184 may direct the associated user to delete the content 180 in operation 188 after the date specified in attribute 182. Any other date or time based attributes 182 can alternatively be used for automatically initiating tasks in the IM process 14.

As described above in FIG. 5, some content may have an associated ratings attribute 192. In yet another embodiment, the IM process 14 in operation 185 may identify any content 180 that has a rating 192 below a predetermined threshold. The identified content 180 may then either be sent back through the IM process workflow for editing and review in operation 186 or may be deleted in operation 188.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

1. An information management system, comprising:
one or more processors configured to operate as an information manager that generates channels for creating, updating or reviewing content and assigns attributes to the channels that determine how the channel content moves through a work flow, the information manager moving the channel content through different work flow paths according to conditions associated with the channel attributes.

2. The information management system according to claim 1 wherein the information manager automatically sends information associated with the channel content to inboxes of users having user profiles corresponding with the channel content attributes.

3. The information management system according to claim 1 wherein the information manager sends information associated with the channel content to one or more users having a user profile corresponding with user skills identified in the channel attributes.

4. The information management system according to claim 3 wherein the information manager determines when a task associated with the channel content has been completed by the one or more users and then automatically sends at least some of the information associated with the channel content to one or more users having a user profile corresponding with different user skills identified in the channel attributes.

5. The information management system according to claim 3 wherein the information manager automatically sends out a notice when the task has not been accepted by at least one of the users within a predetermined acceptance time period.

6. The information management system according to claim 3 wherein the information manager automatically sends out a notice when the task has been accepted by at least one of the users but the task has not been completed by the accepting user within a predetermined completion time period.

7. The information management system according to claim 1 wherein the information manager assigns rating values to content associated with the channels according to one or more user inputs that are then used by a search process to identify content responsive to user queries.

8. The information management system according to claim 7 wherein the information manager assigns reputation values to authors creating the content according to the user inputs that are then used by the search process to identify content responsive to the user queries.

9. The information management system according to claim 1 wherein the information manager assigns time values to content associated with the channels and then automatically identifies content with expired time values.

10. The information management system according to claim 9 wherein the information manager creates recommendations for changes to the identified content and then sends tasks to users having profiles corresponding with the channel attributes to create or modify content associated with the channels.

11. A method comprising:
creating channels;
creating tasks associated with the channels for sending to one or more users over a network;
creating workflows and assigning attributes to the workflows that determine which users are qualified for performing the tasks;
assigning workflows to channels;
comparing profiles for the users with the attributes; and
sending the tasks to the users having profiles corresponding with the attributes required to perform the tasks.

12. The method according to claim 11 including:
receiving a content recommendation;
generating one or more tasks pursuant to the content recommendation;
sending the one or more tasks to a first group of one or more users having profiles that correspond with a first attribute associated with creating content pursuant to the content recommendation;
detecting when the content has been created by the first group of one or more users;
sending one or more tasks to a second group of one or more users having user profiles that correspond with a second attribute associated with reviewing the content created by the first group of one or more users;
detecting when the content is reviewed by the second group of users; and
sending one or more tasks to a third group of one or more users having user profiles that correspond with a third attribute associated with publishing the reviewed content for use with a search engine.

13. The method according to claim 11 including:
analyzing results provided by a search engine;
making content recommendations according to the analyzed results; and
automatically sending tasks for creating, reviewing and publishing new content responsive to the content recommendations.

14. The method according to claim 13 including:
identifying common intents for groups of queries sent to the search engine;
comparing the identified intents with content used by the search engine; and
automatically creating content recommendations when content does not provide sufficient responses to the identified intents.

15. The method according to claim 11 including:
associating a user skills attribute to at least some of the channels that identify types of users having skills qualified for creating or reviewing content associated with the channels; and
sending tasks to the users having profiles corresponding with the user skills attribute associated with the channels.

16. The method according to claim 11 including:
associating security attributes with at least some of the channels that identify a level of access for content associated with the channels; and
sending the tasks to users having profiles corresponding with the security attributes.

17. A method, comprising:
generating a channel that automatically causes tasks to be sent to different users for different work flow stages according to different attributes assigned to the channel and then automatically sending the tasks back to the same users or to different users in other work flow stages according to the channel attributes and conditions associated with the work flow stages.

18. The method according to claim 17 including assigning an overall rating for the content according to the ratings from the first set of users.

19. The method according to claim 18 including using the assigned overall rating during a search process.

20. The method according to claim 19 including:
identifying authors creating the content;
identifying ratings from multiple different users for die content; and
assigning reputation values to the authors according to the identified ratings from the different users.

21. The method according to claim 17 including:
assigning time values to content associated with the tasks;
storing the content on a database accessed through a website or through a search engine;
periodically identifying content in the database having expired time values; and
automatically creating tasks for either updating or deleting the identified content.

22. The method according to claim 17 further comprising sharing channel definitions across organizational groups while restricting management of channel content stored in the channel by organizational group.

23. The method according to claim 17 further comprising subdividing a repository of information associated with the channel into logical views that provide a group of users access to a limited portion of the repository of information.

24. The method according to claim 17 further comprising:
generating a master document;
translating the master document into multiple other languages; and
categorizing the master document and the multiple translations of the master document so that a category assigned to the master document is also applied to the multiple transactions.
